(19) United States
(12) Patent Application Publication
(10) Pub. No.: US 2008/0026960 A1
(43) Pub. Date: Jan. 31, 2008

(54) Degradable particulates and associated methods

(75) Inventors: Trinidad Munoz, Duncan, OK (US); Kirk L. Schreiner, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 11/522,345

(22) Filed: Sep. 15, 2006

Related U.S. Application Data
(63) Continuation-in-part of application No. 11/492,642, filed on Jul. 25, 2006.

(51) Int. Cl. C09K 8/60

(52) U.S. Cl. 507/219

(57) ABSTRACT

Methods that include a method comprising: providing a degradable polymer and one solvent, wherein the solvent comprises an aqueous fluid selected from the group consisting of fresh water, salt water, brine, seawater, and combinations thereof; combining the degradable polymer and the solvent to form a degradable polymer composition; allowing the degradable polymer to at least partially plasticize; and applying sufficient shear to the degradable polymer composition so that degradable particulates begin to form. Additional methods are provided.

### CROSS-REFERENCE TO RELATED APPLICATIONS

This application is a continuation-in-part of U.S. application Ser. No. 11/492,642 filed on Jul. 25, 2006, the entire disclosure of which is incorporated by reference.

### BACKGROUND

The present invention generally relates to methods for producing degradable particulates, and methods related to the use of such degradable particulates in subterranean applications.

Degradable particulates comprise degradable materials (which are oftentimes degradable polymers) that are capable of undergoing an irreversible degradation when used in subterranean applications, e.g., in a well bore. As used herein, the terms “particulate” or “particulates” refer to a particle or particles that may have a physical shape of platelets, shavings, fibers, flakes, ribbons, rods, strips, spheroids, toroids, pellets, tablets, or any other suitable shape. The term “irreversible” as used herein means that the degradable material should degrade in situ (e.g., within a well bore) but should not recrystallize or reconsolidate in situ after degradation (e.g., in a well bore). The terms “degradation” or “degradable” refer to both the two relatively extreme cases of hydrolytic degradation that the degradable material may undergo, e.g., heterogeneous (or bulk erosion) and homogeneous (or surface erosion), and any stage of degradation in between these two. This degradation can be a result of, inter alia, a chemical or thermal reaction, or a reaction induced by radiation. The terms “polymer” or “polymers” as used herein do not imply any particular degree of polymerization; for instance, oligomers are encompassed within this definition.

The degradability of a degradable polymer often depends, at least in part, on its backbone structure. For instance, the presence of hydrolyzable and/or oxidizable linkages in the backbone often yields a material that will degrade as described herein. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., temperature, presence of moisture, oxygen, microorganisms, enzymes, pH, and the like.

The physical properties of degradable polymers depend on several factors such as the composition of the repeat units, flexibility of the chain, presence of polar groups, molecular mass, degree of branching, crystallinity, orientation, etc. For example, short chain branches reduce the degree of crystallinity of polymers while long chain branches lower the melt viscosity and impart, inter alia, extensional viscosity with tension-stiffening behavior. The properties of the material utilized can be further tailored by blending, and copolymerizing it with another polymer, or by changing the macromolecular architecture (e.g., hyper-branched polymers, star-shaped, or dendrimers, etc.). The properties of any such suitable degradable polymers (e.g., hydrophobicity, hydrophilicity, rate of degradation, etc.) can be tailored by introducing select functional groups along the polymer chains.

Common methods that have been used to produce degradable particulates useful in subterranean applications (e.g., as acid precursors, fluid loss control particles, diverting agents, filter cake components, drilling fluid additives, cement additives, etc.) include, inter alia, emulsion methods and solution precipitation methods. To prepare degradable particulates using the emulsion method, typically a degradable polymeric material, such as poly(lactic acid), is dissolved in a halogenated solvent, e.g. methylene chloride, to form a polymeric solution and subsequently, water and a surfactant are then added to the polymeric solution at sufficient shear to form an emulsion. After formation of the emulsion, the solvent may then be removed from the emulsion by vacuum stripping or steam stripping, leaving behind essentially solvent-free particles of the polymer in the aqueous phase. The water is then removed and the particles may be collected by centrifugation, filtration, or spray-drying. Similarly, preparing degradable particulates with solution precipitation methods involves dissolution of a degradable polymer in a water miscible solvent to form a polymeric solution. Surfactants and/or water are then added to the polymeric solution with sufficient shear such that the solvent partitions from the polymeric solution, leaving behind essentially solvent-free particles of the polymer which may be collected by the same methods already discussed.

One problem associated with the current methods of producing degradable particulates is the necessity of surfactants and/or multiple solvents. Both the emulsion method and the solution precipitation method require the use of more than one solvent and/or surfactant. Furthermore, the halogenated solvents that may be used in these methods may pose health and environmental concerns. Thus, it may be beneficial and more cost-effective to have a method of producing degradable particulates that do not require the use of surfactants and/or multiple solvents, including halogenated solvents.

### SUMMARY

The present invention generally relates to methods for producing degradable particulates, and methods related to the use of such degradable particulates in subterranean applications.

In one embodiment, the present invention provides a method comprising providing a degradable polymer and one solvent, wherein the solvent comprises an aqueous fluid selected from the group consisting of fresh water, salt water, brine, seawater, and combinations thereof; combining the degradable polymer and the solvent to form a degradable polymer composition; allowing the degradable polymer to at least partially plasticize; and applying sufficient shear to the degradable polymer composition so that degradable particulates begin to form.

In another embodiment, the present invention provides a method comprising providing a degradable polymer and a solvent consisting essentially of an aqueous fluid selected from the group consisting of fresh water, salt water, brine, seawater, and combinations thereof; combining the degradable polymer and the solvent to form a degradable polymer composition; allowing the degradable polymer to at least partially plasticize; applying sufficient shear to the degradable polymer composition so that degradable particulates begin to form; and incorporating at least a portion of the degradable particulates into a treatment fluid.

In yet another embodiment, the present invention provides a method comprising providing a degradable polymer and one solvent, wherein the solvent comprises an aqueous fluid selected from the group consisting of fresh water, salt water, brine, seawater, and combinations thereof; combining the degradable polymer and the solvent to form a degradable polymer composition; allowing the degradable polymer to at least partially plasticize; applying sufficient shear to the degradable polymer composition so that degradable particulates begin to form; incorporating at least a portion of the degradable particulates into a gravel pack composition; and allowing the degradable particulates to degrade.

The features and advantages of the present invention will be readily apparent to those skilled in the art upon a reading of the description of the embodiments that follows.

### BRIEF DESCRIPTION OF THE DRAWINGS

These drawings illustrate certain aspects of some of the embodiments of the present invention, and should not be used to limit or define the invention.

FIG. 1 graphically illustrates a particle size distribution of some degradable particulates produced as a result of the methods of the present invention.

FIG. 2 graphically illustrates a particle size distribution of some degradable particulates produced as a result of the methods of the present invention.

### DESCRIPTION OF PREFERRED EMBODIMENTS

The present invention generally relates to methods for producing degradable particulates, and methods related to the use of such degradable particulates in subterranean applications. One of the many advantages offered by the methods and compositions of the present invention is the ability to generate the degradable particulates of the present invention without the use of surfactants and/or multiple solvents. Additionally, another advantage is that the degradable particulates of the present invention may be generated without the use of halogenated solvents that may pose health and environmental concerns.

In accordance with the methods of the present invention, a degradable polymer is combined with one solvent so as to form a degradable polymer composition. The solvent in the degradable polymer composition is then allowed to at least partially plasticize the degradable polymer. The term “plasticize,” as used herein, refers to the softening or increasing in pliability of the degradable polymer. Optionally, the degradable polymer composition may be stirred and/or gently heated to facilitate the plasticizing of the degradable polymer. Any suitable mixing and/or heating device may be used. After the degradable polymer has been at least partially plasticized, sufficient shear may then be applied to the degradable polymer composition so that degradable particulates begin to form. In some embodiments, the shear applied may be about 5000 revolutions per minute (“rpm”) or higher. Any suitable shearing device may be used in these methods including, but not limited to, high speed dispersers, jet nozzles, in-line mixers (with various screens), and the like.

Examples of suitable degradable polymers that may be used in conjunction with the methods of the present invention include, but are not limited to, aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); poly ether esters, polyester amides, polyamides, and copolymers, combinations, or derivatives thereof. The term “copolymer” as used herein is not limited to the combination of two polymers, but includes any combination of polymers, e.g., terpolymers and the like. Of these suitable polymers, aliphatic polyesters such as poly(lactic acid), poly(anhydrides), poly(orthoesters), and poly(lactide)-co-poly(glycolide) copolymers are preferred. In some embodiments, the degradable polymer may be poly(lactic acid). In other embodiments, the degradable polymer may be poly(orthoesters). Other degradable polymers that are subject to hydrolytic degradation also may be suitable. The selection of an appropriate degradable polymer may depend on the particular application and the conditions involved. Other guidelines to consider include the degradation products that result, the time for required for the requisite degree of degradation, and the desired result of the degradation (e.g., voids). Also, the relative degree of crystallinity and amorphousness of a particular degradable polymer can affect the relative hardness of the degradable particulates. Examples of other suitable degradable polymers include those degradable polymers that release useful or desirable degradation products that are desirable, e.g., an acid. Such degradation products may be useful in a downhole application, e.g., to break a viscosified treatment fluid or an acid soluble component present therein (such as in a filter cake).

Suitable aliphatic polyesters may have the general formula of repeating units shown below:

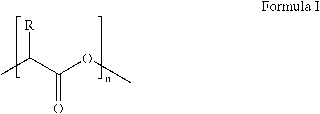

where n is an integer between 75 and 10,000 and R is a hydrogen, alkyl, aryl, alkylaryl, acetyl, heteroatoms, or mixtures thereof. Of these aliphatic polyesters, poly(lactide) is preferred. Poly(lactide) is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to formula I without any limitation as to how the polymer was made such as from lactides, lactic acid, or oligomers, and without reference to the degree of polymerization or level of plasticization. The lactide monomer exists generally in three different forms: two stereoisomers L- and D-lactide and racemic D,L-lactide (meso-lactide). The oligomers of lactic acid, and oligomers of lactide are defined by the formula:

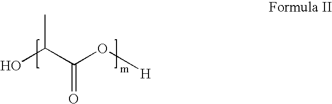

where m is an integer 2≦m≦75. Preferably m is an integer and 2≦m≦10. These limits correspond to number average molecular weights below about 5,400 and below about 720, respectively. The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in applications of the present invention where a slower degradation of the degradable particulates is desired. Poly(D,L-lactide) may be a more amorphous polymer with a resultant faster hydrolysis rate. This may be suitable for other applications where a more rapid degradation may be appropriate. The stereoisomers of lactic acid may be used individually or combined to be used in accordance with the present invention. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified to be used in the present invention by, inter alia, blending, copolymerizing or otherwise mixing the stereoisomers, blending, copolymerizing or otherwise mixing high and low molecular weight poly(lactides), or by blending, copolymerizing or otherwise mixing a poly(lactide) with another polyester or polyesters.

Solvents suitable for use in the present invention should, among other things, at least partially plasticize the degradable polymer. For example, solvents suitable for use in the present invention may plasticize the degradable polymer thereby softening and/or increasing the pliability of the degradable polymer. Any solvent that is capable of plasticizing a degradable polymer may be suitable for use in the present invention. Examples of suitable solvents include, but are not limited to, aqueous fluids, including but not limited to, fresh water, salt water, brine, or seawater, or any other aqueous based fluid that does not adversely react with the other components used in accordance with this invention or with the subterranean formation; methanol; ethanol; propylene carbonate; propylene glycol; polyethylene glycol; isopropanol; polyhydric alcohols such as glycerol polyethylene oxide; oligomeric lactic acid; citrate esters (such as tributyl citrate oligomers, triethyl citrate, acetyltributyl citrate, and acetyltriethyl citrate); glucose monoesters; partially fatty acid esters; PEG monolaurate; triacetin; poly(ε-caprolactone); poly(hydroxybutyrate); glycerin-1-benzoate-2,3-dilaurate; glycerin-2-benzoate-1,3-dilaurate; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations or derivatives thereof. In some embodiments, the solvent may consist essentially of an aqueous fluid. The choice of which particular solvent to use may be determined by the particular degradable polymer, the concentration of the degradable polymer in the degradable polymer composition, and other similar factors. While the methods of the present invention only require the use of one solvent, in some embodiments, this solvent may be a combination of suitable solvents or a suitable solvent that has been diluted with an aqueous fluid. In certain embodiments, the solvent should be included in an amount sufficient to at least partially plasticize the degradable polymer. In some embodiments, the solvent may be included in the degradable polymer composition in an amount in the range of from about 1% to about 99.9% by volume. In other embodiments, the solvent may be included in the degradable polymer composition in an amount in the range of from about 5% to about 80% by volume. In another embodiment, the solvent may be included in the degradable polymer composition in an amount in the range of from about 10% to about 50% by volume.

Additionally, while halogenated solvents such as chloroform, dichloromethane, 1,2-dichlorobenzene, dimethylformamide, etc. may be used to plasticize a degradable polymer, these solvents may not be desirable due to safety concerns, potential environmental issues, potential safety issues in terms of flash point and potential exposure, and relative cost.

The average size distribution of the degradable particulates produced from the methods of the present invention may vary, depending on several factors. These factors include, but are not limited to, the type and/or amount of solvent used, the particular degradable polymer used, the molecular weight of the degradable polymer, the concentration of the degradable polymer in the degradable polymer composition, the amount of shear applied, the presence of certain additives, the temperature conditions, etc. The desired average particulate size distribution can be modified as desired by modifying any of these factors. One of ordinary skill in the art with the benefit of this disclosure will be able to identify the particular factor(s) to modify to achieve a desired particulate size distribution.

The degradable particulates of the present invention can be used in any subterranean application with or without a treatment fluid, depending on the use. As used herein, the term “treatment fluid” refers to any fluid that may be used in a subterranean application in conjunction with a desired function and/or for a desired purpose. The term “treatment fluid” does not imply any particular action by the fluid or any component thereof. One of ordinary skill in the art with the benefit of this disclosure will be able to recognize when the degradable particulates may or may not be used in conjunction with a treatment fluid. One consideration is the ability to incorporate the degradable particulates in the treatment fluid. Another consideration is the timing desired for the degradation of the degradable particulates. Another consideration is the concentration of degradable particulates needed in a chosen treatment fluid.

The degradable particulates may have differing properties, such as, relative hardness, pliability, degradation rate, etc. depending on the processing factors, the type of degradable polymer used, etc. The specific properties of the degradable particulates produced may vary by varying certain process parameters (including compositions), which will be evident to one of ordinary skill in the art with the benefit of this disclosure. Depending on the particular use, the degradable particulates may have several purposes, including, but not limited to, creating voids upon degradation, releasing certain desirable degradation products that may then be useful for a particular function, and/or temporarily restricting the flow of a fluid. Examples of subterranean applications in which the generated degradable particulates could be used include, but are not limited to, such applications as fluid loss control particles, as diverting agents, as filter cake components, as drilling fluid additives, as cement composition additives, or other acid-precursor components. Specific nonlimiting embodiments of some examples are discussed below.

In some methods, the degradable particulates may be used to increase the conductivity of a fracture. This may be accomplished by incorporating the degradable particulates into a fracturing fluid comprising proppant particulates, allowing the proppant particulates to form a proppant matrix within a fracture that comprises the degradable particulates, and allowing the degradable particulates to degrade to form voids within the proppant matrix. The term “proppant matrix” refers to some consolidation of proppant particulates.

In another example of a subterranean application, the degradable particulates may be used to divert a fluid within a subterranean formation.

In another example, the degradable particulates may be used in a composition designed to provide some degree of sand control to a portion of a subterranean formation. In an example of such a method, the degradable particulates may be incorporated into a cement composition which is placed down hole in a manner so as to provide some degree of sand control. An example of such a cement composition comprises a hydraulic cement, sufficient water to form a pumpable slurry, and the degradable particulates formed by a method of this invention. Optionally, other additives used in cementing compositions may be added.

In another example, the degradable particulates may be incorporated into a cement composition to be used in a primary cementing operation, such as cementing casing in a well bore penetrating a subterranean formation. An example of such a cement composition comprises a hydraulic cement, sufficient water to form a pumpable slurry, and the degradable particulates formed by a method of this invention. Optionally, other additives used in cementing compositions may be added.

In another example, the degradable particulates may be incorporated in a gravel pack composition. Upon degradation of the degradable particulates, any acid-based degradation products may be used to degrade an acid-soluble component in the subterranean formation, including but not limited to a portion of a filter cake situated therein.

In another example, the degradable particulates may be incorporated with a viscosified treatment fluid (e.g., a fracturing fluid or a gravel pack fluid) to act as a breaker for the viscosified treatment fluid (i.e., at least partially reduce the viscosity of the viscosified treatment fluid).

In another example, the degradable particulates may be used as self-degrading bridging agents in a filter cake.

In another example, the degradable particulates may be used as a fluid loss control additive for at least partially controlling or minimizing fluid loss during a subterranean treatment such as fracturing.

In another example, the degradable particulates may be used in conjunction with cleaning or cutting a surface in a subterranean formation.

To facilitate a better understanding of the present invention, the following examples of preferred embodiments are given. In no way should the following examples be read to limit, or to define, the scope of the invention.

### EXAMPLE 1

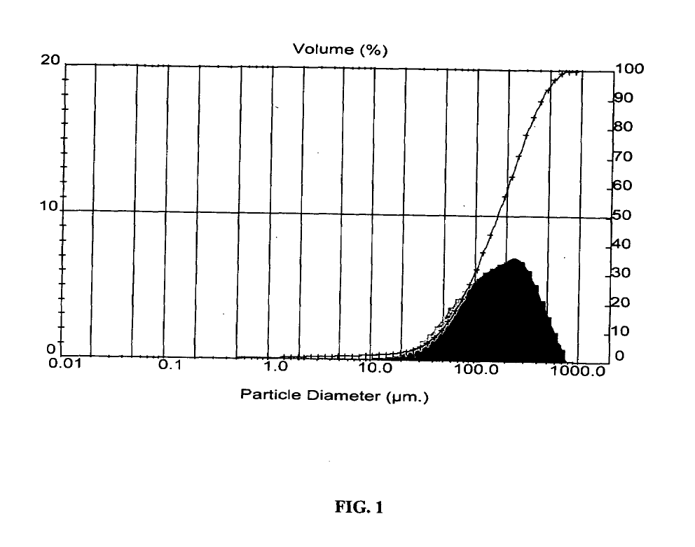

Degradable particulates of the present invention were made by placing 100 grams (“g”) of amorphous poly(lactic) acid in 1000 milliliters (“mL”) of methanol. The resulting solution was then heated, with stirring, to no more than 110° F. and held for approximately 3 hours to plasticize the poly(lactic) acid. Thereafter, the methanol was decanted, leaving plasticized poly(lactic) acid and 500 mL of methanol was then added back to the plasticized poly(lactic). The solution was then sheared in a Silverson L4RT-A Lab Mixer with a large screen for approximately 5 minutes at 5500 rpm, 10 minutes at 7000 rpm and finally 9500 rpm for 10 minutes. The resulting degradable particulates were then collected by allowing them to settle to the bottom of the solution and decanting the methanol. Referring now to FIG. 1, the particle size distribution of the resulting degradable particulates is indicated. In addition, it can be seen that the median particle size produced was approximately 164 μm.

### EXAMPLE 2

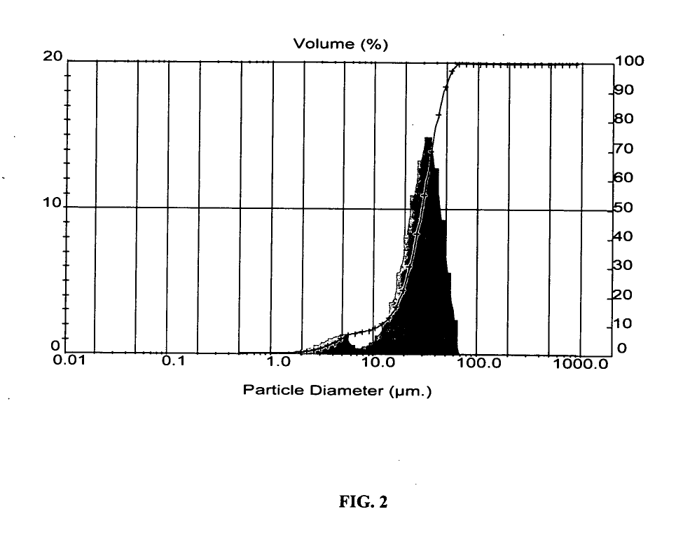

Degradable particulates of the present invention were made by placing 100 grams (“g”) of crystalline poly(lactic) acid in 1000 milliliters (“mL”) of fresh water. The solution was then sheared in a Silverson L4RT-A Lab Mixer with a large screen, having a hole diameter of approximately 0.056 inches, for approximately 5 minutes at 5500 rpm and 10 minutes at 7000 rpm. The large screen on the Lab Mixer was then replaced with a small screen, having a hole diameter of approximately 0.015 inches, and the solution was sheared at 9500 for 25-30 minutes. The resulting degradable particulates were then collected by allowing them to settle to the bottom of the solution and decanting the water. Referring now to FIG. 2, the particle size distribution of the resulting degradable particulates is indicated. In addition, it can be seen that the median particle size produced was approximately 30 μm.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. While numerous changes may be made by those skilled in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a degradable polymer and one solvent, wherein the solvent comprises an aqueous fluid selected from the group consisting of fresh water, salt water, brine, seawater, and combinations thereof;
combining the degradable polymer and the solvent to form a degradable polymer composition;
allowing the degradable polymer to at least partially plasticize; and
applying sufficient shear to the degradable polymer composition so that degradable particulates begin to form.

2. The method of claim 1 wherein the solvent is not halogenated.

3. The method of claim 1 wherein the step of allowing the degradable polymer to at least partially plasticize further comprises stirring and/or heating the degradable polymer composition.

4. The method of claim 1 wherein the step of applying sufficient shear comprises applying shear in an amount of about 5000 revolutions per minute.

5. The method of claim 1 wherein the degradable polymer is selected from the group consisting of: aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); poly ether esters; polyester amides; polyamides; and copolymers, combinations, or derivatives thereof.

6. The method of claim 1 wherein the degradable polymer is an aliphatic polyester selected from the group consisting of poly(lactic acid), poly(anhydrides), poly(orthoesters), and poly(lactide)-co-poly(glycolide) copolymers.

7. The method of claim 1 wherein the solvent further comprises at least one of the following: methanol; ethanol; propylene carbonate; propylene glycol; polyethylene glycol; isopropanol; polyhydric alcohols; glycerol polyethylene oxide; oligomeric lactic acid; citrate esters; tributyl citrate oligomers; triethyl citrate; acetyltributyl citrate; acetyltriethyl citrate; glucose monoesters; partially fatty acid esters; PEG monolaurate; triacetin; poly(e-caprolactone); poly(hydroxybutyrate); glycerin-1-benzoate-2,3-dilaurate; glycerin-2-benzoate-1,3-dilaurate; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations or derivatives thereof.

8. The method of claim 1 wherein the solvent is present in the degradable polymer composition in an amount in the range of from about 10% to about 50% by volume.

9. The method of claim 1 further comprising using at least a portion of the degradable particulates in a subterranean application to divert a fluid within the subterranean formation.

10. The method of claim 1 further comprising incorporating at least a portion of the degradable particulates into a viscosified treatment fluid, the degradable particulates being capable of acting as a viscosity breaker for the viscosified treatment fluid.

11. The method of claim 1 further comprising incorporating at least a portion of the degradable particulates into a gravel pack.

12. The method of claim 1 further comprising incorporating at least a portion of the degradable particulates into a filter cake, at least a portion of the degradable particulates being capable of acting as degradable bridging agents in the filter cake.

13. The method of claim 1 further comprising placing at least a portion of the degradable particulates in a cement composition that comprises a hydraulic cement and water.

14. The method of claim 1 further comprising: incorporating at least a portion of the degradable particulates into a fracturing fluid that comprises proppant particulates; allowing a portion of the proppant particulates to form a proppant matrix that comprises at least a plurality of the degradable particulates within a fracture in a subterranean formation; and allowing the degradable particulates to degrade so as to form at least one void in the proppant matrix.

15. A method comprising:
providing a degradable polymer and a solvent consisting essentially of an aqueous fluid selected from the group consisting of fresh water, salt water, brine, seawater, and combinations thereof;
combining the degradable polymer and the solvent to form a degradable polymer composition;
allowing the degradable polymer to at least partially plasticize;
applying sufficient shear to the degradable polymer composition so that degradable particulates begin to form; and
incorporating at least a portion of the degradable particulates into a treatment fluid.

16. The method of claim 15 wherein the degradable polymer is selected from the group consisting of: aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); poly ether esters; polyester amides; polyamides; and copolymers, combinations, or derivatives thereof.

17. The method of claim 15 wherein the degradable polymer is an aliphatic polyester selected from the group consisting of poly(lactic acid), poly(anhydrides), poly(orthoesters), and poly(lactide)-co-poly(glycolide) copolymers.

18. A method comprising:
providing a degradable polymer and one solvent, wherein the solvent comprises an aqueous fluid selected from the group consisting of fresh water, salt water, brine, seawater, and combinations thereof;
combining the degradable polymer and the solvent to form a degradable polymer composition;
allowing the degradable polymer to at least partially plasticize;
applying sufficient shear to the degradable polymer composition so that degradable particulates begin to form;
incorporating at least a portion of the degradable particulates into a gravel pack composition; and
allowing the degradable particulates to degrade.

19. The method of claim 18 wherein the degradable polymer is selected from the group consisting of: aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); poly ether esters; polyester amides; polyamides; and copolymers, combinations, or derivatives thereof.

20. The method of claim 18 wherein the solvent further comprises at least one of the following: methanol; ethanol; propylene carbonate; propylene glycol; polyethylene glycol; isopropanol; polyhydric alcohols; glycerol polyethylene oxide; oligomeric lactic acid; citrate esters; tributyl citrate oligomers; triethyl citrate; acetyltributyl citrate; acetyltriethyl citrate; glucose monoesters; partially fatty acid esters; PEG monolaurate; triacetin; poly(e-caprolactone); poly(hydroxybutyrate); glycerin-1-benzoate-2,3-dilaurate; glycerin-2-benzoate-1,3-dilaurate; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations or derivatives thereof.
